(19) United States
(12) Patent Application Publication
(10) Pub. No.: US 2025/0265493 A1
(43) Pub. Date: Aug. 21, 2025

(54) INFERRING USER VENUE VISITS IN NEAR-REAL TIME

(71) Applicant: Snap Inc., Santa Monica, CA (US)

(72) Inventors: Alexander Farivar, Santa Monica, CA (US); Christopher Shughrue, Canaan, NY (US); Sushant Wason, San Francisco, CA (US); Xiaohan Zhao, West Windsor, NJ (US); Haokai Xu, San Mateo, CA (US); Kalvin Thye, New York, NY (US)

(21) Appl. No.: 18/583,592

(22) Filed: Feb. 21, 2024

(51) Int. Cl. G06N 20/00

(52) U.S. Cl. CPC G06N 20/00

(57) ABSTRACT

A method and system including receiving, at a computing device, a user location; retrieving a set of candidate venues based on the user location; retrieving check-in data associated with each candidate venue where the check-in data includes user check-ins for a plurality of users; predicting a venue score for each candidate venue, the predicting using one or more of a machine learned (ML) model, the check-in data for the candidate venue, or the user location; identifying a candidate venue with a highest predicted venue score as the predicted venue for the user location, and determining a user visit associated with the predicted venue. The user location includes latitude and longitude information. ML model features include venue-associated conditional probabilities, each conditional probability for a venue being a probability that the user location is generated by a probability distribution modeling venue-associated check-in data. The probability distribution can be a bivariate Gaussian distribution.

### TECHNICAL FIELD

The disclosed subject matter relates generally to the technical field of location technology and in some examples, to a system and method for inferring user venue visits in near real-time.

### BACKGROUND

Many platforms and applications offer location-based or location-aware features, such as finding friends or connections nearby, recommending businesses or attractions of interest, highlighting promotions, sales, or events available at a venue being visited by a user, and so forth. Such features depend on retrieving or inferring a current location of the user, and/or a current place or venue visited by the user.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system that has both client-side and server-side functionality, according to some examples.

FIG. 3 is a diagrammatic representation of an inferred visitation system, according to some examples.

FIG. 4 is an illustration of user check-in locations around a venue, according to some examples.

FIG. 5 is an illustration of a real-time inferred visit call-out for a user, displayed to the user's connections on a base map, according to some examples.

FIG. 6 illustrates a method as implemented by an inferred visitation system, according to some examples.

FIG. 7 is a block diagram showing a machine-learning program, according to some examples.

FIG. 8 is a diagrammatic representation of a data structure as maintained in a database, according to some examples.

FIG. 9 is a diagrammatic representation of a message, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

Many platforms and applications offer location-based or location-aware features, from finding friends nearby to recommending businesses or attractions of interest, highlighting promotions, sales or events available at a visited venue, and so forth. However, determining the venues being visited by users is technically challenging. Many users are only comfortable with sharing or making visible minimal location information, due to privacy, data storage, data use, or data re-sharing considerations. Users moving around a city or neighborhood may not explicitly specify the business or destination they are visiting, may visit more than one place in a neighborhood, and may make or alter visit plans in real-time. Furthermore, many platforms or applications rely on available place or venue databases to bootstrap the set of venues used for location-aware feature, or to anchor or match user's self-reported or self-tagged location information. However, such place databases can have inconsistent or limited coverage, while stored coordinates of specific places or venues can be incorrect and/or outdated. Thus, a user's tracked or shared location coordinates may not match the coordinates of a visited place or venue as available in the place database used by the platform or application.

A platform or application that offers location-aware features may seek to ensure that the location or venue information retrieved and/or inferred for a specific user is of high-quality and up to date, to avoid a bad user experience caused by presenting irrelevant or misleading recommendations or other location-sensitive information. Furthermore, inferring venues and/or venue visits in a scalable fashion is advantageous for a platform or application with many users and/or frequently updating location information. Thus, there is a need for a technical solution to the technical problem of high quality, near real-time identification of venues or places visited by users who may share only minimal user location information, in the context of incomplete or partially inaccurate place databases.

Examples in the disclosure herein refer to a scalable method and system for inferring venues visited by a user in near real-time based on user location data. In some examples, the system accesses or receives a user location including a latitude and a longitude. Given the user location, the system retrieves a set of candidate venues within a predetermined distance of the user location. For each candidate venue, the system retrieves a set of past check-ins, each check-in corresponding to a post or shared media item tagged with a place (e.g., the candidate venue), and/or associated with location information (e.g., latitude and longitude). In some examples, the system uses the user location and/or the check-in data associated with each candidate venue to compute or predict a venue score indicating how likely the user is to be at the respective candidate venue. The venue with the highest predicted venue score is retained as the most likely venue, or the predicted venue, associated with the user location. In some examples, the venue with the highest predicted venue score is only retained as the predicted venue if the highest predicted venue score transgresses a pre-defined confidence threshold. In some examples, the system further determines whether the user is visiting the respective venue, or merely passing by or through the venue. The predicted venue information and/or inferred visit information can be made available to downstream components that provide location-aware features to the user.

In some examples, given the set of candidate venues, the system uses a machine learned (ML) model to compute predicted venue scores for the candidate venues. The ML model can be a supervised model, such as a multi-class classifier. Features used by the ML model can include conditional probabilities associated with the candidate venues, each conditional probability for a respective venue corresponding to a probability that the user location is generated by a probability distribution estimated based on check-in data associated with the respective venue. Features can further include a venue-associated normalized conditional probability for each venue (corresponding to the ratio between the venue-specific conditional probability and the sum of the conditional probabilities for the candidate venues), a distance between the user location and a centroid of venue-associated check-ins for each venue, and/or other features.

In some examples, generating a conditional probability associated with a candidate venue includes computing parameters of a probability distribution fitting the check-in data associated with the venue, and/or computing the probability that the user location is generated by the probability distribution with the determined parameters. In some examples, the probability distribution is a bivariate distribution such as a bivariate Gaussian distribution. The computed parameters can include a centroid of venue-associated check-ins, a covariance matrix, and/or other parameters.

In some examples, the system receives an updated user location. The system retrieves an updated set of neighboring candidate venues based on the updated user location, and/or retrieves check-in data associated with each updated candidate venue. Given the updated candidate venues, the system uses the ML model to predict venue scores for the updated set of venues, indicating how likely the user is to be at each of the updated venues. The updated venue with the highest such score is retained as the most likely updated venue, or the predicted updated venue, associated with the updated user location. In some examples, the updated venue with the highest such score is only retained as the predicted updated venue, if the respective score transgresses a pre-defined confidence threshold. The pre-defined confidence threshold can be selected from a set of thresholds automatically identified by the system using a test or development data and/or relationships between the score thresholds and performance measures such as precision and/or coverage, as part of an automatic calibration process.

In some examples, the system can use the predicted venue (associated with the user location) and/or the predicted updated venue (associated with the updated user location) to determine or infer a user visit of the predicted venue. In some examples, inferring a user visit of the predicted venue is based on determining that the predicted venue matches the predicted updated venue (e.g., they correspond to the same venue, or one of them is nested within the other, etc.). In some examples, inferring the user visit of the predicted venue can require that the time period between receiving the user location and receiving the updated user location transgresses a pre-defined duration threshold (e.g., is smaller than a pre-defined number of minutes, etc.). In some examples, the system can use explicit check-in information and/or explicit feedback about a user not having visited a venue at a particular time to improve the visit detection rules.

In some examples, the system's use of a trained ML model and/or a set of lightweight rules or conditions for visit detection allows for near real-time inference user visits to venues, representing an improvement over more expensive, and/or delayed visit inference approaches. Near real-time user visit inferences allow for more immediate and relevant user experiences, such as timely recommendations or social interactions based on a current user location. The use of calibrated thresholds for venue scores associated with predicted venues ensures that the precision and coverage of the venue prediction model and overall system satisfy the needs of a developer, platform, or application. The quality of the inferred user visits is further improved by the included mechanisms for detecting and/or validating user visits, such as assessing the consistency of predictions over time and/or incorporating user-provided feedback. This can help to reduce false positives and ensure that the system's inferences align with actual user behavior. Furthermore, separating the venue prediction, visit detection and/or visit duration or visit end detection steps allows for optimizing venue prediction accuracy, and for improving flexibility with respect to defining a visit, its duration and/or end in different ways for different downstream use cases or applications.

By inferring visits without requiring users to share extensive location or identifying information, the system can be beneficial for users who are concerned about privacy, but are interested in location-aware features. Computing user location-associated probabilities using distributions that approximate venue-associated check-in data provides a flexible way of comparing a user location to collective, anonymized locations of other users with respect to a set of venues. Thus, the system can provide high-quality venue identification results even in the absence of a complete and entirely accurate place database. Furthermore, modeling venue-associated check-in data using bivariate Gaussian distributions relies on estimating and storing a small number of parameters, a suitable approach for platforms or applications handling a large number of users and/or frequently updating, dynamic location information.

Overall, the system herein implements a near immediate, highly accurate, and privacy-friendly approach to location-based visit detection.

### Networked Computing Environment

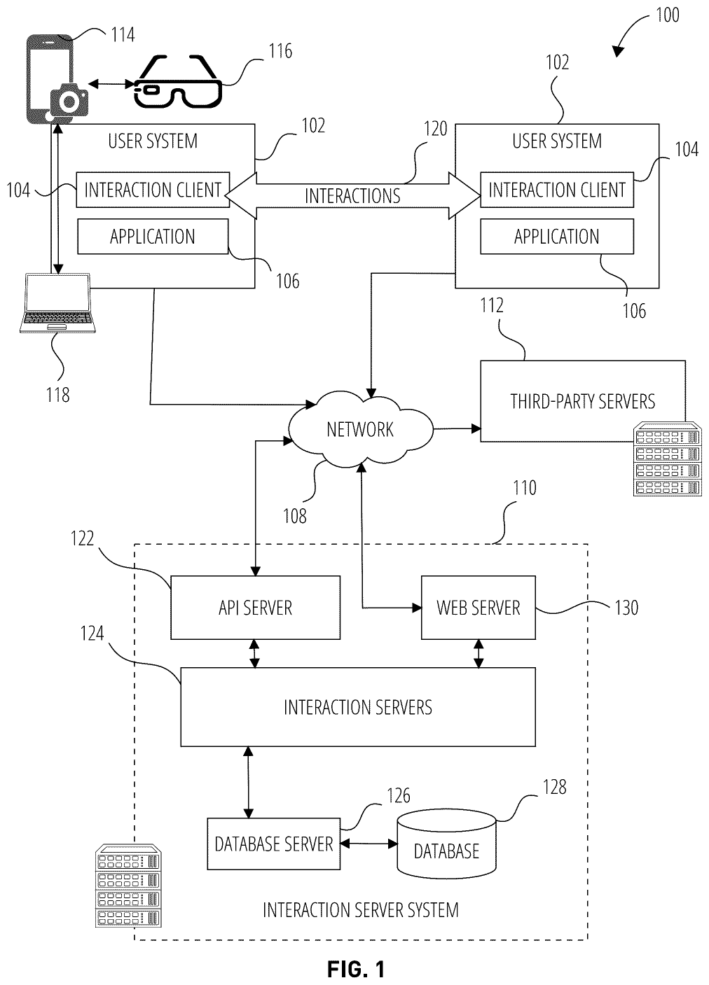

FIG. 1 is a diagrammatic representation of a networked environment in which the present disclosure may be deployed, according to some examples. FIG. 1 shows an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 810); the location of friends within an entity relationship graph; and opening an application event (e.g., relating to the interaction client 104).

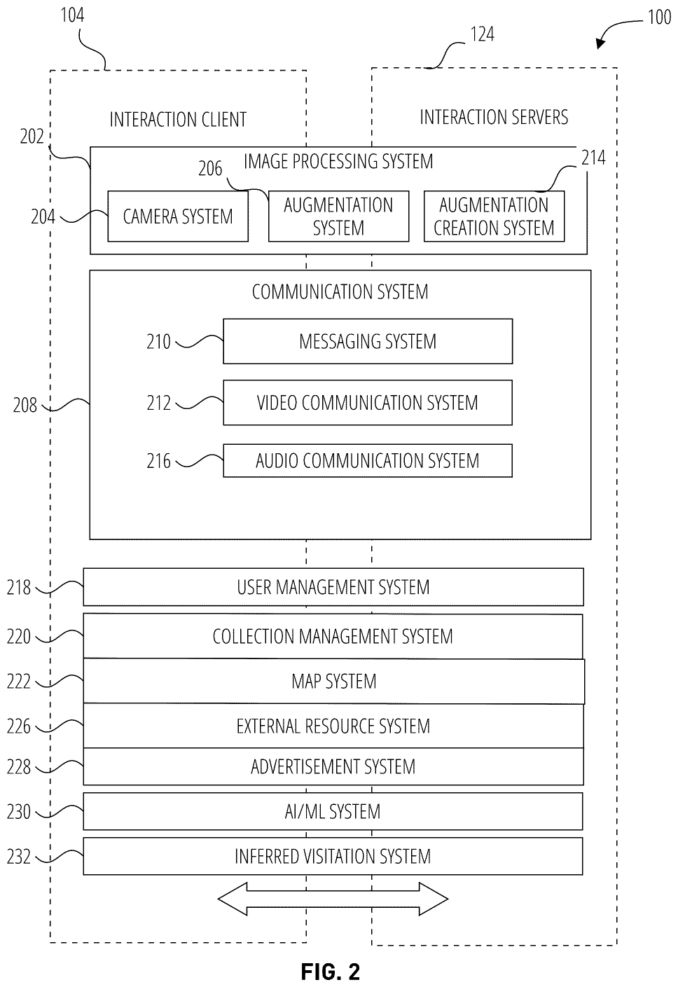

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 1006 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 808, entity graphs 810 and profile data 802) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An AI/ML system 230 provides a variety of services to different subsystems within the interaction system 100. For example, the AI/ML system 230 operates with the image processing system 202 and the camera system 204 to analyze images and extract information such as objects, text, or faces. This information can then be used by image processing system 202 to enhance, filter, or manipulate images. The AI/ML system 230 may be used by the augmentation system 206 to generate augmented content and augmented reality experiences, such as adding virtual objects or animations to real-world images. The communication system 208 and messaging system 210 may use the AI/ML system 230 to analyze communication patterns and provide insights into how users interact with each other and provide intelligent message classification and tagging, such as categorizing messages based on sentiment or topic. The AI/ML system 230 may also provide chatbot functionality to message interactions 120 between user systems 102 and between a user system 102 and the interaction server system 110. The AI/ML system 230 may also work with the audio communication system 216 to provide speech recognition and natural language processing capabilities, allowing users to interact with the interaction system 100 using voice commands.

An inferred visitation system 232 is used to infer user visits of venues or places, in order to enable location-aware features (in conjunction, for example, with the map system 222 module). In some examples, the inferred visitation system 232 uses functionality provided by the AI/ML system 230, or can be integrated, partially or fully, in the AI/ML system 230.

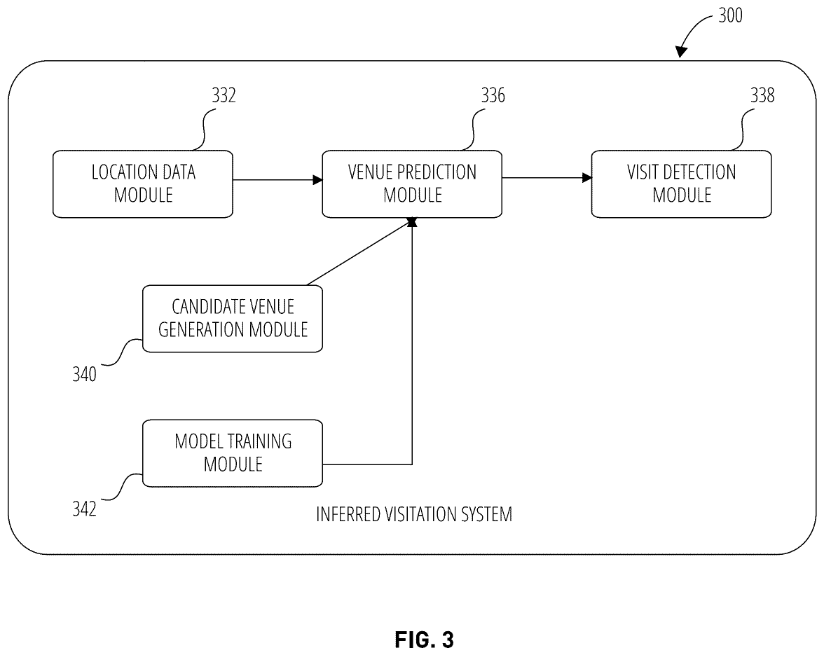

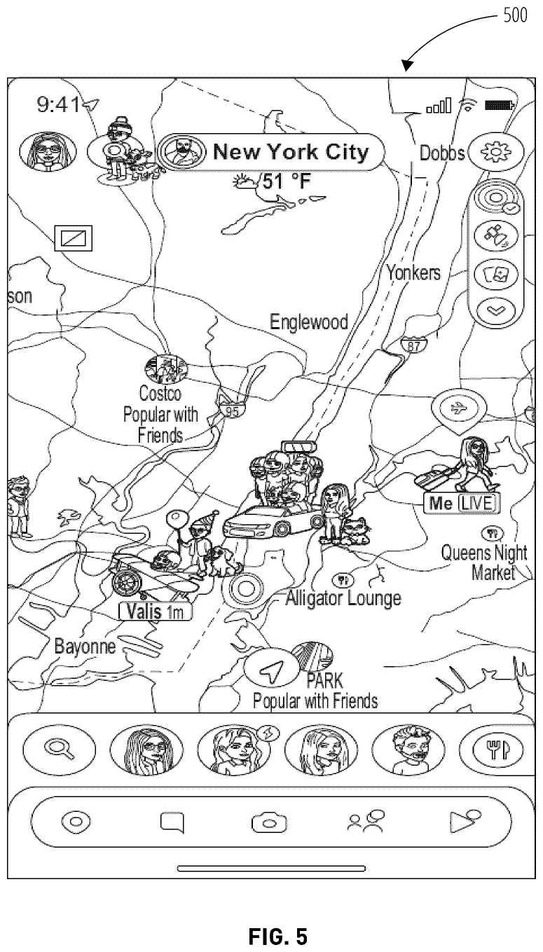

FIG. 3 is a diagrammatic representation of an inferred visitation system 300, according to some examples (corresponding, for example, to inferred visitation system 232 in FIG. 2). The inferred visitation system 300 predicts near real-time visits to venues based on user location information. The inferred visitation system 300 includes a venue prediction module 336 that takes input from a location data module 332, a candidate venue generation module 340, a module model training module 342, and/or a visit detection module 338. Given a user location, the venue prediction module 336 outputs a predicted venue together with a confidence score. The visit detection module 338 uses a series of outputs of the venue prediction module 336 to further determine whether and where a user visit has taken or taking place. In some examples, the inferred visitation system 300 provides venue-specific visit information to downstream components or use cases, such as map-based applications, displaying personalized buildings on a map, base map callouts, and so forth (see, e.g., FIG. 5).

In some examples, the location data module 332 receives or collects client information (e.g., user and/or device information) such as latitude and longitude, time, user speed, Wi-Fi SSID, GPS (Global Positioning System) accuracy information, or other information. The inferred visitation system 300 uses such client information to predict, in near real-time, the venue most relevant or likely to match the client location information (e.g., a user location as indicated by latitude and longitude). Given a determination that a user has been at a venue, the inferred visitation system 300 further infers if the user has visited the venue, or merely passed by or through the venue. For illustrative purposes, the disclosure primarily refers to a user's location, however the methods and/or examples disclosed apply to a device's location, and/or other types of retrieved location information (e.g., the device can be a tracker placed on a pet, a backup tracking device placed on a second computing device, and so forth).

Given a current user location, the inferred visitation system 300 uses the candidate venue generation module 340 to retrieve a set of N candidate venues (e.g., N=up to 70/80/90/100/etc.), ordered by distance from the user location. Candidate venues can fall within a pre-determined distance D of the location (e.g., D<=250 m), or contain the user location within a geofence (if available), to be returned as a candidate.

Given a current user location and a set of candidate venues, the inferred visitation system 300 uses the venue prediction module 336 to predict venue scores (e.g., probability scores, confidence scores, etc.) for K candidate venues associated with the current location (where K≤N). A computed or predicted venue score indicates how likely the user is to be at the venue. In some examples, the venue prediction module 336 uses a machine learning (ML) model to compute venue predictions and/or associated venue scores. For example, the venue prediction module 336 can use a multi-class classification framework and/or associated classifier (e.g., a one-vs-rest multi-class classifier implemented using XGBoost, Random Forest, and so forth). In some examples, the venue prediction module 336 can use a binary classifier (e.g., given an example including a client or user location and a venue, the classifier classifies the example as a True or False venue, with an associated confidence or prediction score).

In some examples, the classifier is trained using the model training module 342, as further described below. The training can be conducted in an offline setting, or in a mixed offline/online setting.

The inferred visitation system 300 can use a variety of features for venue prediction, as seen in Table 1.

TABLE 1
Examples of features used for venue prediction.

| Feature | Description | Type |
|---|---|---|
| Conditional venue | Conditional probability point estimate | Float |
| probability | | (0, 1) |
| Normalized venue | Conditional venue probability normalized by | Float |
| probability | sum over candidate venues | (0, 1) |
| Candidate venue | Rank among candidates by conditional venue | Integer |
| rank | probability score | (1, N) |
| λ | Parameter of exponential distribution fit to | Float |
| | venue check-ins around check-ins centroid | (0, 1) |
| Geofence | Flag indicating if client falls within | Boolean |
| intersection | available geofence | |
| Nearby places | Count of candidate venues | Integer |
| | | (1, N) |
| Candidate | Distance from client location to centroid of | Float |
| distance | venue check-ins | (0, Inf) |
| GPS accuracy | Accuracy of client location | Float |
| | | (0, inf) |
| Client speed | Instantaneous speed of client | Float |
| | | (0, Inf) |
| Wi-Fi connection | Flag indicating if client is connected to | Boolean |
| | Wi-Fi | |

In some examples, the inferred visitation system 300 uses features that characterize the client, such as GPS accuracy, geofence intersection feature, and so forth. In some examples, the features characterize a candidate venue in relation to the client location (e.g., the user location). For example, the candidate venue can be modeled using a set of available venue associated check-ins by other users and/or devices. For the purposes of the disclosure herein, check-ins refer, for example, to snaps, or posts (e.g., story posts) tagged with place information (e.g., corresponding to a place ID from a database of place IDs) via sticker, filter, caption, place tagging or geofilter. Check-ins are associated with check-in latitude/longitude information. To preserve privacy, check-in data is anonymized before being received or accessed by the inferred visitation system 300.

For each venue and a set of associated explicit check-ins, the inferred visitation system 300 can use a distribution, such as bivariate distribution (e.g., a bivariate Gaussian distribution, etc.) to model the set of venue-associated check-ins. For example, the inferred visitation system 300 can compute a centroid for the set of check-ins, or a covariance matrix for the target distribution. Such parameter can be automatically computed offline according to a pre-determined schedule (e.g., every 12 hrs./every 24 hrs./every 48 hrs., etc.). In some examples, the pre-determined schedule can be automatically adjusted based on the type of venue (e.g., long-established venue versus newly opened venue), venue category (e.g., recreational venue, institution, etc.), seasonal factors, and/or other factors. In some examples, a venue can be further characterized by an available venue pin. The venue pin location can be the same or different from the check-in centroid location.

The inferred visitation system 300 can compute measures and/or features indicating how closely associated a client location (e.g., a user location) is to a candidate venue, based on an available model for the candidate venue. For example, the inferred visitation system 300 can compute the distance between the client location and the venue-associated centroid. Additionally, the inferred visitation system 300 can compute a conditional probability of the client location given an estimated distribution based on the set of venue-associated past check-ins. This probability corresponds to a measure of how close the client location is to the past check-ins for the specific venue.

In some examples, the distribution is a bivariate Gaussian or normal distribution, which is associated with the following joint probability density function (PDF):

$${f}_{XY} ( x , y ) = \frac{1}{2 {πσ}_{X} {σ}_{Y} \sqrt{1 - {ρ}^{2}}} * \text{?}$$

$$\text{?} \text{indicates text missing or illegible when filed}$$

ρ, σ_{X}, σ_{Y} are defined by the covariance matrix which is computed based on a subset of the available explicit check-in data (e.g., using a sample covariance matrix calculation, maximum likelihood estimation (MLE), Bayesian estimation, shrinkage methods, or other estimation methods);
μ_{X}, μ_{Y} characterize the venue-specific centroid of the Gaussian distribution, computed based available check-ins;
x, y indicate the current location of interest (e.g., with a latitude component and a longitude component).

The inferred visitation system 300 uses the joint PDF formula showcased above to compute the instantaneous probability f_{XY} (x,y) that the current location, characterized by (x,y), corresponds to a point generated by the relevant venue-associated Gaussian distribution, whose parameters have been estimated as indicated above. The disclosure herein refers to this probability as the conditional venue probability (e.g., venue probability conditioned on the distribution characterizing past venue check-ins).

In some examples, the inferred visitation system 300 further computes a normalized probability (see Table 1) for each venue, corresponding to the ratio between the conditional venue probability and the sum of the conditional venue probabilities for candidate venues. The system can use the rank of a venue with respect to the venue set based on the conditional venue probability scores. The inferred visitation system 300 can use the distance between the client location and the centroid of the venue. The inferred visitation system 300 may fit a univariate distribution, such as an exponential distribution, to the venue check-ins, and the lambda parameter of the estimated exponential distribution can be included in the set of features. In some examples, the inferred visitation system 300 can check if a venue has an associated geofence, and if so, whether the client location falls within the geofence-a resulting Boolean indicator feature can be added to the ML model feature set.

Given a client location and a set of candidate venues, the inferred visitation system 300 can use the ML model (e.g., the multi-class classifier) to predict, for each venue, the probability that the client location is associated with that venue rather than the rest of the candidate venues. The venue with the highest prediction score or probability among the candidate venues is the overall predicted venue associated with the client location.

Training, Assessment and/or Calibration of Venue Prediction Model

The model training module 342 trains the ML model using explicit check-in data (e.g., 1 million test check-ins or subsets thereof). The training can take place offline, according to a predetermined schedule (e.g., for example, every 48 hrs./every week/etc.). A (client location, venue) example is a positive example (an example with a positive label) if the venue is a correct check-in venue for the client location. A (client location, venue) example is a negative example (an example with a negative label) if the venue is an incorrect check-in venue for the client location. While explicit check-in data provides positive labels, the inferred visitation systems 300 can derive information about negative labels (corresponding to incorrect associations of client locations with venues), by assuming that a user can only be visiting one venue at the time, and therefore an association of a client location with a different venue at that time is a negative example. In some examples, the inferred visitation system 300 can receive user-supplied “I am not here” posts and/or flag values associated with an inferred venue for the user. Such data can be used as a source of explicit negative labels in augmenting the training set for the ML classifier or in the assessment of venue prediction results.

The ML model is calibrated using threshold-precision boundaries. The result of the venue prediction module 336 can be provided to a downstream module if the prediction score associated with the most likely venue (or a normalized version of the prediction score) transgresses one or more thresholds, associated with a determined precision and/or coverage on the test data. For instance, using a venue score threshold of 0.92 can lead to the venue being predicted with 97% precision on ˜18% of the test data. Using a venue score threshold of 0.74 leads to a 90% precision venue prediction for 47% of the test data. Using a venue score threshold of 0 can lead to the venue being predicted with 71.3% precision over the entire test data. In some examples, the inferred visitation system 300 can automatically select a venue score threshold (e.g., based on receiving input from a developer with respect to a desired threshold level of precision or coverage), or can use a developer-supplied threshold.

### Venue Visit Detection

As a client location is updated (e.g., as the user's latitude and/or longitude change), the inferred visitation system 300 can compute successive near real-time venue predictions. The visit detection module 338 can use a series of successive venue predictions to determine whether the user is likely to have visited the venue or merely passed by or through the venue.

In some examples, the visit detection module 338 can use a set of rules and/or tests for determining whether a user visited a specific venue or not. The visit detection module 338 can determine that the specific venue was visited by the user if one or more of the rules or tests apply. For example, the visit detection module 338 can assess or determine the following quantities:
a) Venue prediction confidence, corresponding to a threshold for the venue score for venue predicted by the venue prediction module 336, or to a precision and/or coverage level associated with a venue prediction model version. For example, the visit detection module 338 can determine whether the venue was predicted by a ML model with an assessed precision level greater or equal than 0.9/0.95/etc. The visit detection module 338 can alternatively determine whether the venue score for the most likely venue predicted by the venue prediction module 336 is greater or equal to 0.90/0.92/0.95/etc.
b) Venue prediction consistency, corresponding to an indicator of whether a series of K successive predictions for the user correspond to the same predicted venue, or different venues (e.g., K>=2).
c) Duration, corresponding to an indicator of how much time (hours/minutes/etc.) have passed since the last location update and/or last computed venue prediction. In some examples, the duration is computed since the previously computed venue prediction if the previously computed venue is the same as the currently computed venue (e.g., the duration should be 1 minute/2 minute/etc.).

In some examples, the visit detection module 338 can determine that a true visit by a user has occurred at a venue if one or more of the conditions below are met:
a) the venue prediction module 336 uses a venue prediction model with 97% precision (e.g., with a 97% associated probability of producing a correct prediction).
b) the same venue was repeatedly predicted in the most recent successive venue predictions for the given user.
c) the venue was most recently predicted no more than 1 minute before the last or current prediction.

Condition a) above corresponds to assessed confidence in venue prediction results, condition b) corresponds to assessed consistency of venue prediction, and condition c) corresponds to a duration assessment or determination. Alternatively, if the above conditions and/or a subset thereof are not met, the inferred visitation system 300 determines that a visit has not occurred, and/or the user merely passed by the venue. In some examples, using all of the above conditions, venue predictions will be treated as true visits when successive predictions return the same venue with high confidence for a minimum duration of 1 minute.

If the visit detection module 338 determines that the user has visited a venue, the visit detection module 338 can further determine when and/or if a visit has ended or not. In some examples, the visit detection module 338 determines the visit has ended if one or more of the conditions below have been met:
a) the venue prediction module 336 uses a venue prediction model with an associated probability of a correct prediction that transgresses a pre-determined threshold (e.g., the associated probability is smaller than a 0.95 probability).
b) the visit detection module 338 has predicted that the user and/or device is at two different venues in two successive predictions.
c) the time since last location update and/or most recent venue prediction has exceeded M minutes or hours, for a pre-defined M (e.g., M>1 hr.)

In some examples, the visit detection module 338 can apply rules and/or conditions such as those described above, while iteratively refining them using logging data. In some examples, explicit user-provided input indicating that a user is or is not visiting a specific venue can provide additional data for refining the rules and/or conditions. In some examples, the visit detection module 338 can use a ML model, such as supervised ML model, to determine whether a visit or not has occurred at a specific venue. The model training data can be derived based on explicitly provided user indications that a visit has taken or is taking place at a venue at a particular time, or conversely, that a user is not visiting a particular venue at a particular time. In some examples, venues can be nested (e.g., a building venue can be nested within a campus venue, a restaurant can be nested in a mall, etc.). The inferred visitation system 300 can assume that only one venue is the correct venue. Alternatively, the inferred visitation system 300 can allow for multiple valid venues, and the classification or prediction model used can be one that accommodates multi-output classification, allowing a user location to be mapped to more than one valid venue.

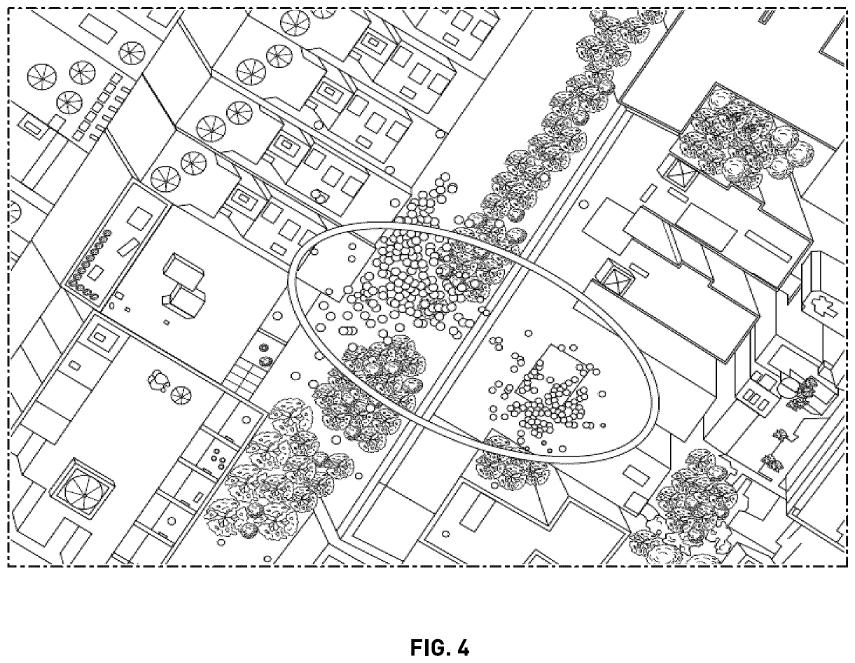

FIG. 4 is an illustration of user check-in locations around a venue, according to some examples. FIG. 4 illustrates check-ins at or around the Carbone restaurant in New York City. The illustrated ellipsoid corresponds to a spatial distribution of the check-ins. In the illustrated example, the spatial distribution of the check-ins can be modeled or approximated using a bivariate distribution, such as a bivariate Gaussian distribution.

FIG. 5 is an illustration of a real-time inferred visit call out for a user, displayed to the user's connections on a base map 500, according to some examples.

In some examples, the real-time or nearly real-time inferred visit for a user will be stored and/or displayed adjacent to a name, icon, or other visual indicator of a place on a base map 500. The base map 500 is displayed, with the user's permission, to a user's connections. By showcasing the inferred visit on a base map, the inferred visitation system 300 facilitates a more intuitive connection between connections (or friends) and places. In some examples, the inferred visitation system 300 can store anonymized inferred user visits, which can be subsequently aggregated at the level of places, cities, regions, and so forth. The inferred visitation system 300 can use such aggregated information to identify trending or popular places and/or associated visit patterns (e.g., average time spent, etc.), which can in turn be used by a recommender component. For example, given an explicitly specified or inferred user location and/or user visit of a place, a recommender component can recommend other trending or popular places nearby, or within a user-specified radius.

In some examples, upon determining a user visit associated with a specific location and/or place, the inferred visitation system 300 can provide the user with information about offers and/or promotions related to the location and/or place, as retrieved from a database or from an internal or third-party API.

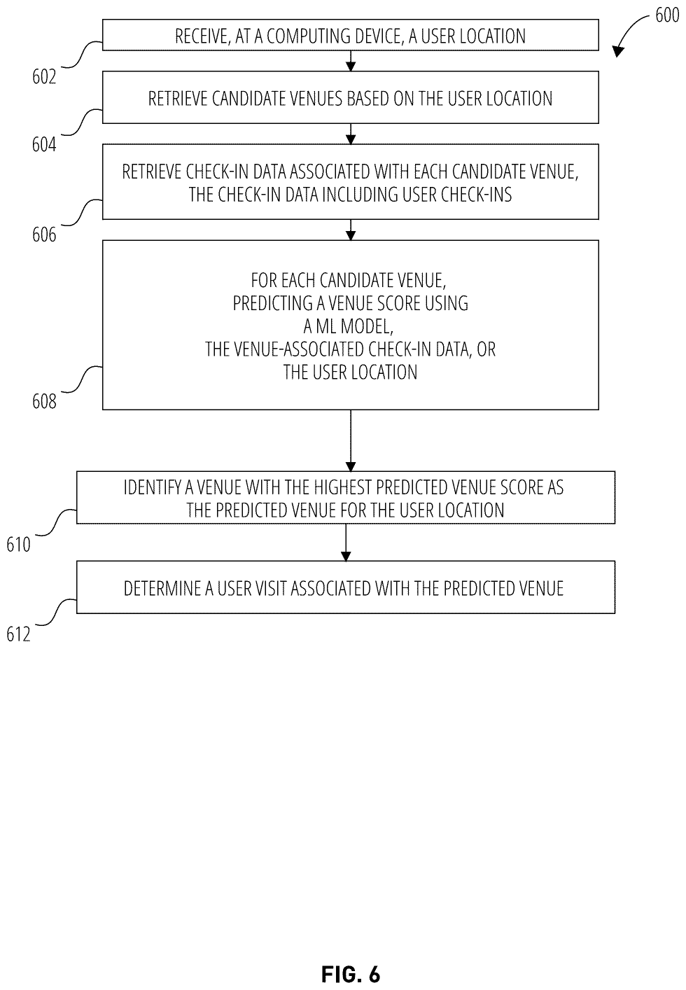

FIG. 6 is a flowchart illustrating a method 600 for inferring user visits, as implemented by the inferred visitation system 300, according to some examples. At operation 602, the inferred visitation system 300 receives user location data, which is used to retrieve candidate neighboring venues (at operation 604). The user location data can include latitude and longitude information. The inferred visitation system 300 retrieves user check-in data, such as user check-in locations including latitude and longitude values, for each of the candidate venues (at operation 606). For each candidate venue, at operation 608, the inferred visitation system 300 predicts a venue score indicating how likely the user is to be at the candidate venue, the predicting using one or more of a machine learned (ML) model, the user location, or the venue-associated retrieved check-ins. In some examples, the inferred visitation system 300 computes the venue scores for the candidate venues using a supervised multi-class classifier.

The inferred visitation system 300 retains the candidate venue with the highest associated predicted venue score as the predicted venue associated with the user location (at operation 610). In some examples, the inferred visitation system 300 retains the respective candidate venue as the predicted venue only if the associated predicted venue score is higher than a pre-defined threshold.

The inferred visitation system 300 determines, at operation 612, whether the user has in fact visited the predicted venue or has merely passed by the venue.

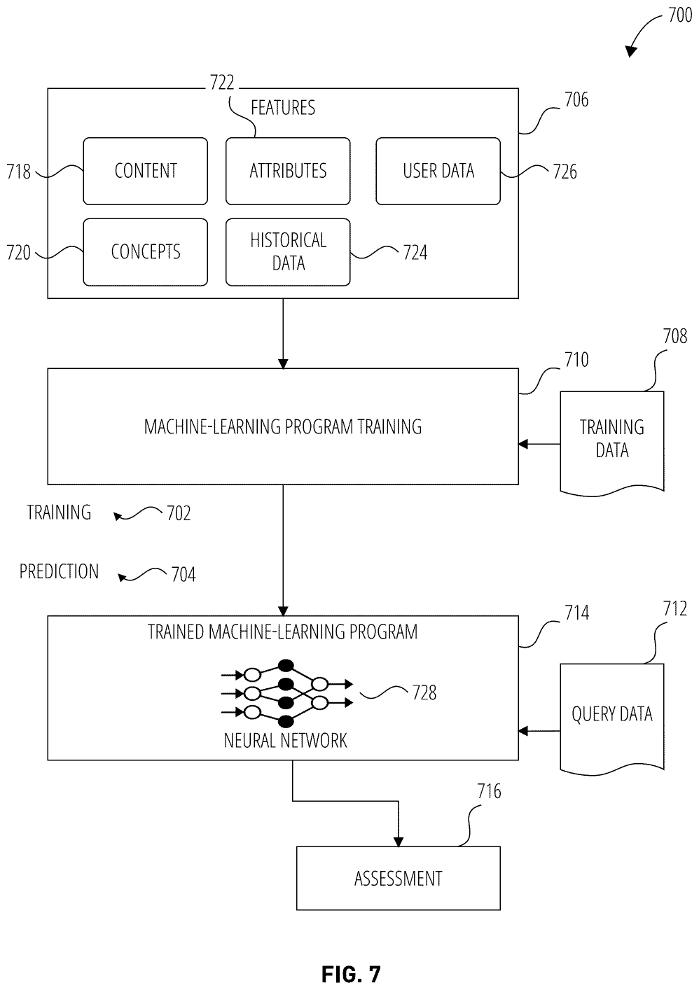

FIG. 7 is a block diagram showing a machine-learning program 700 according to some examples. The machine-learning program 700, also referred to as machine-learning algorithms or tools, are used to train machine learning models, which can be used by the inferred visitation system 300, as described at least in FIG. 3 herein.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 708 in order to make data-driven predictions or decisions expressed as outputs or assessments (e.g., assessment 716). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g., stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 700 supports two types of phases, namely a training phase 702 and prediction phase 704. In a training phase 702, supervised learning, unsupervised or reinforcement learning may be used. For example, the machine-learning program 700 (1) receives features 706 (e.g., as structured or labeled data in supervised learning) and/or (2) identifies features 706 (e.g., unstructured, or unlabeled data for unsupervised learning) in training data 708. In a prediction phase 704, the machine-learning program 700 uses the features 706 for analyzing input (or query) data 712 to generate outcomes or predictions, as examples of an assessment 716.

In the training phase 702, feature engineering is used to identify features 706 and may include identifying informative, discriminating, and independent features for the effective operation of the machine-learning program 700 in pattern recognition, classification, and regression. In some examples, the training data 708 includes labeled data, which is known data for pre-identified features 706 and one or more outcomes. Each of the features 706 may be a variable or attribute, such as individual measurable property of a process, article, system, or phenomenon represented by a data set (e.g., the training data 708). Features 706 may also be of different types, such as numeric features, strings, and graphs, and may include one or more of content 718, concepts 720, attributes 722, historical data 724 and/or user data 726, merely for example.

In training phase 702, the machine-learning program 700 uses the training data 708 to find correlations among the features 706 that affect a predicted outcome or assessment 716.

With the training data 708 and the identified features 706, the machine-learning program 700 is trained during the training phase 702 at machine-learning program training 710. The machine-learning program 700 appraises values of the features 706 as they correlate to the training data 708. The result of the training is the trained machine-learning program 714 (e.g., a trained or learned model).

Further, the training phase 702 may involve machine learning (such as deep learning), in which the training data 708 is structured (e.g., labeled during preprocessing operations), and the trained machine-learning program 714 implements a relatively simple neural network 728 (or one of other machine learning models, as described herein) capable of performing, for example, classification and clustering operations. In other examples, the training phase 702 may involve training data 708 which is unstructured, and the trained machine-learning program 714 implements a deep neural network 728 that is able to perform both feature extraction and classification/clustering operations.

A neural network 728 generated or trained during the training phase 702 and implemented within the trained machine-learning program 714, may include a hierarchical (e.g., layered) organization of neurons. For example, neurons (or nodes) may be arranged hierarchically into a number of layers, including an input layer, an output layer, and multiple hidden layers. The layers within the neural network 728 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 728 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), a network with a transformer architecture, and so forth (merely for example).

During prediction phase 704 the trained machine-learning program 714 is used to perform an assessment. Query data 712 is provided as an input to the trained machine-learning program 700, and the trained machine-learning program 714 generates the assessment 716 as output, responsive to receipt of the query data 712.

In some examples, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

### Data Architecture

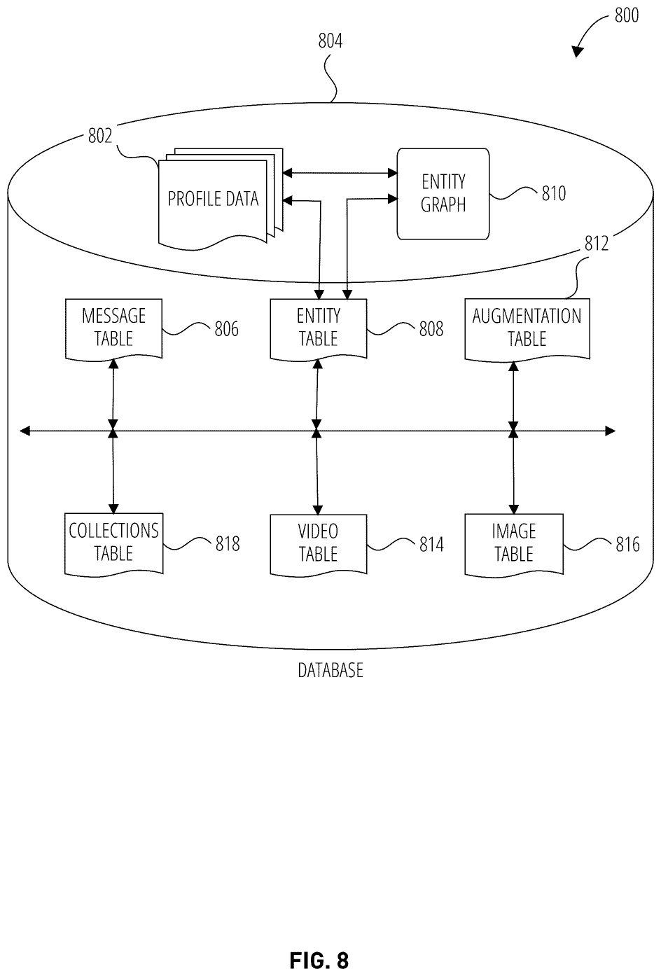

FIG. 8 is a schematic diagram illustrating data structures 800, which may be stored in the database 804 of the interaction server system 110, according to certain examples. While the content of the database 804 is shown to comprise multiple tables, it will be appreciated that the data could be stored in other types of data structures (e.g., as an object-oriented database).

The database 804 includes message data stored within a message table 806. This message data includes, for any particular message, at least message sender data, message recipient (or receiver) data, and a payload. Further details regarding information that may be included in a message, and included within the message data stored in the message table 806, are described below with reference to FIG. 8.

An entity table 808 stores entity data, and is linked (e.g., referentially) to an entity graph 810 and profile data 802. Entities for which records are maintained within the entity table 808 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 810 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 808. Such privacy settings may be applied to all types of relationships within the context of the interaction system 100, or may selectively be applied to certain types of relationships.

The profile data 802 stores multiple types of profile data about a particular entity. The profile data 802 may be selectively used and presented to other users of the interaction system 100 based on privacy settings specified by a particular entity. Where the entity is an individual, the profile data 802 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

The database 804 also stores augmentation data, such as overlays or filters, in an augmentation table 812. The augmentation data is associated with and applied to videos (for which data is stored in a video table 814) and images (for which data is stored in an image table 816).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 816 includes augmented reality content items (e.g., corresponding to applying “lenses” or augmented reality experiences). An augmented reality content item may be a real-time special effect and sound that may be added to an image or a video.

A collections table 818 stores data regarding collections of messages and associated image, video, or audio data, which are compiled into a collection (e.g., a story or a gallery). The creation of a particular collection may be initiated by a particular user (e.g., each user for which a record is maintained in the entity table 808). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 814 stores video data that, in some examples, is associated with messages for which records are maintained within the message table 806. Similarly, the image table 816 stores image data associated with messages for which message data is stored in the entity table 808. The entity table 808 may associate various augmentations from the augmentation table 812 with various images and videos stored in the image table 816 and the video table 814.

### Data Communications Architecture

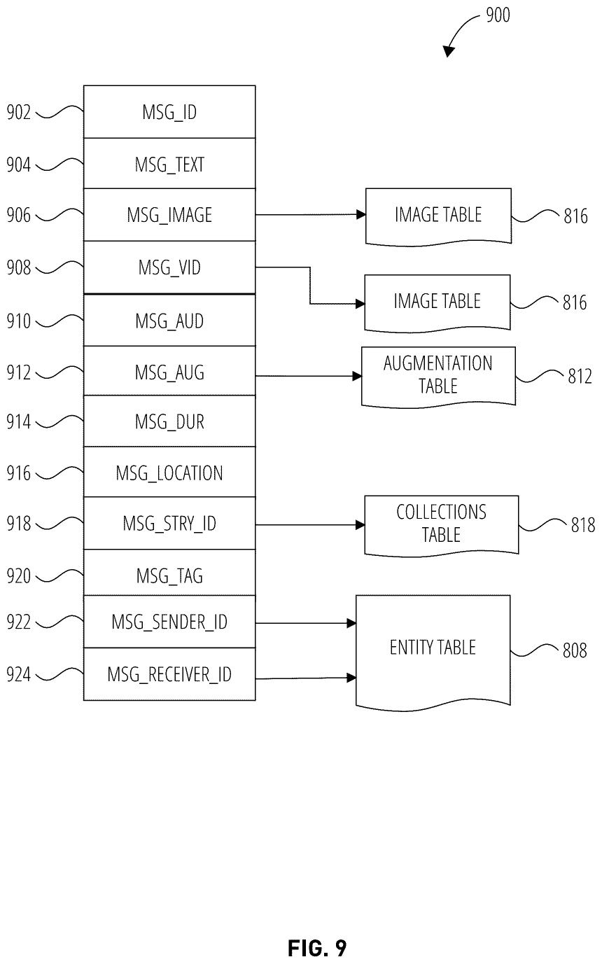

FIG. 9 is a schematic diagram illustrating a structure of a message 900, according to some examples, generated by an interaction client 104 for communication to a further interaction client 104 via the interaction servers 124. The content of a particular message 900 is used to populate the message table 806 stored within the database 804, accessible by the interaction servers 124. Similarly, the content of a message 900 is stored in memory as “in-transit” or “in-flight” data of the user system 102 or the interaction servers 124. A message 900 is shown to include the following example components:
Message identifier 902: a unique identifier that identifies the message 900.
Message text payload 904: text, to be generated by a user via a user interface of the user system 102, and that is included in the message 900.
Message image payload 906: image data, captured by a camera component of a user system 102 or retrieved from a memory component of a user system 102, and that is included in the message 900. Image data for a sent or received message 900 may be stored in the image table 816.
Message video payload 908: video data, captured by a camera component or retrieved from a memory component of the user system 102, and that is included in the message 900. Video data for a sent or received message 900 may be stored in the image table 816.
Message audio payload 910: audio data, captured by a microphone or retrieved from a memory component of the user system 102, and that is included in the message 900.
Message augmentation data 912: augmentation data (e.g., filters, stickers, or other annotations or enhancements) that represents augmentations to be applied to message image payload 906, message video payload 908, or message audio payload 910 of the message 900. Augmentation data for a sent or received message 900 may be stored in the augmentation table 812.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message story identifier 918: identifier values identifying one or more content collections (e.g., “stories” identified in the collections table 818) with which a particular content item in the message image payload 906 of the message 900 is associated. For example, multiple images within the message image payload 906 may each be associated with multiple content collections using identifier values.
Message tag 920: each message 900 may be tagged with multiple tags, each of which is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier, email address, or device identifier) indicative of a user of the user system 102 on which the message 900 was generated and from which the message 900 was sent.
Message receiver identifier 924: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 816. Similarly, values within the message video payload 908 may point to data stored within an image table 816, values stored within the message augmentation data 912 may point to data stored in an augmentation table 812, values stored within the message story identifier 918 may point to data stored in a collections table 818, and values stored within the message sender identifier 922 and the message receiver identifier 924 may point to user records stored within an entity table 808.

### Machine Architecture

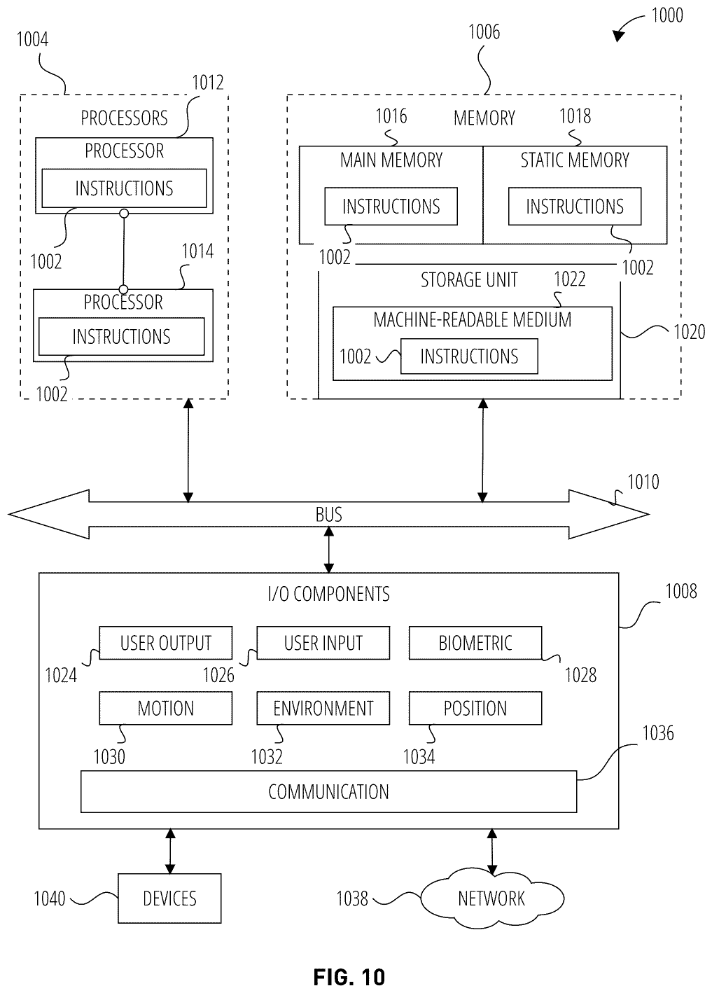

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the interaction server system 110. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which use electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

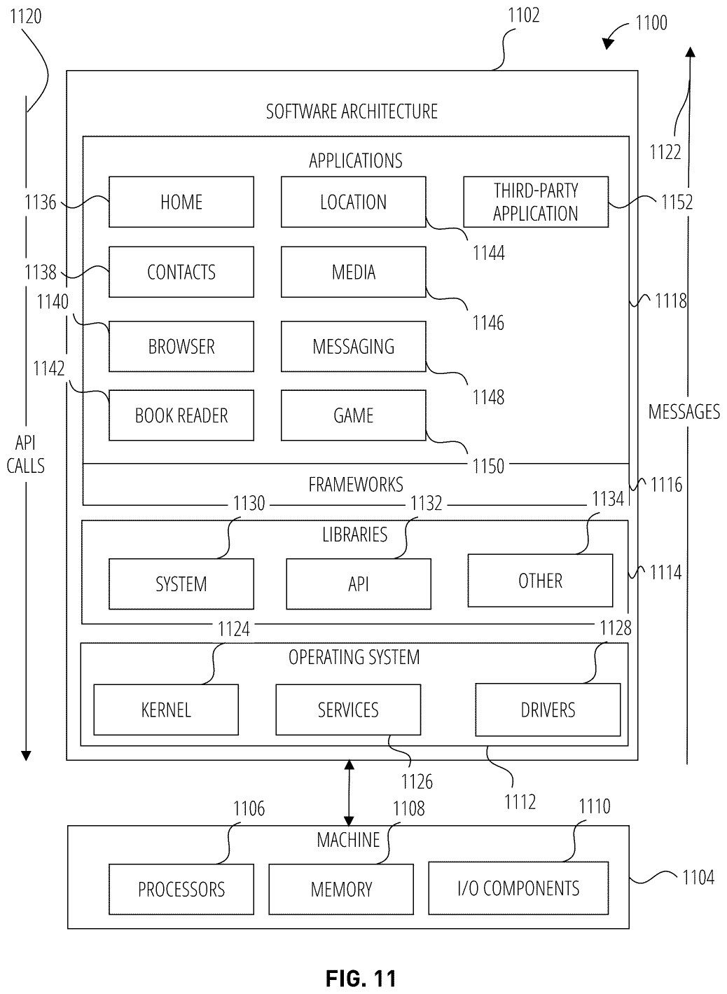

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

### EXAMPLES

Example 1 is a method comprising: receiving, at a computing device, a user location; retrieving a set of candidate venues based on the user location; retrieving check-in data associated with each candidate venue of the set of candidate venues, check-in data comprising user check-ins for a plurality of users; predicting a venue score for each candidate venue, the predicting using one or more of a machine learned (ML) model, the check-in data for the candidate venue, or the user location; identifying a candidate venue of the set of candidate venues with a highest predicted venue score as a predicted venue for the user location; determining that a user visit is associated with the predicted venue; and storing data indicating that the user visit is associated with the predicted venue.

In Example 2, the subject matter of Example 1 includes, wherein the user location comprises a latitude and a longitude.

In Example 3, the subject matter of Examples 1-2 includes, wherein the check-in data for each candidate venue comprises a plurality of latitude and longitude pairs.

In Example 4, the subject matter of Examples 1-3 includes, wherein features of the ML model comprise conditional probabilities associated with the candidate venues, each conditional probability for a respective venue corresponding to a probability that the user location is generated by a probability distribution corresponding to check-in data associated with the venue.

In Example 5, the subject matter of Example 4 includes, wherein generating the conditional probability for the venue further comprises: determining parameters of the probability distribution based on the check-in data associated with the venue; and computing the probability that the user location data is generated by the probability distribution with the determined parameters.

In Example 6, the subject matter of Examples 4-5 includes, wherein the probability distribution is a bivariate Gaussian probability distribution.

In Example 7, the subject matter of Examples 1-6 includes, wherein the ML model is a supervised multi-class classifier.

In Example 8, the subject matter of Examples 1-7 includes, receiving an updated user location; retrieving an updated set of candidate venues based on the updated user location; retrieving updated check-in data associated with each updated candidate venue of the set of updated candidate venues; predicting an updated venue score for each updated candidate venue, of the set of updated candidate venues, using at least one of the ML model, the updated check-in data for each updated candidate venue, or the updated user location; and identifying an updated candidate venue of the set of updated candidate venues with a highest predicted updated venue score as the predicted updated venue.

In Example 9, the subject matter of Example 8 includes, wherein determining the user visit associated with the predicted venue further comprises determining that the predicted venue matches the predicted updated venue.

In Example 10, the subject matter of Example 9 includes, wherein determining the user visit associated with the predicted venue further comprises determining that a time period between receiving the user location and receiving the updated user location transgresses a predefined duration threshold.

In Example 11, the subject matter of Example 10 includes, wherein determining the user visit associated with the predicted venue further comprises determining that: a predicted venue score associated with the predicted venue transgresses a first confidence threshold; and a predicted updated venue score associated with the predicted updated venue transgresses a second confidence threshold.

In Example 12, the subject matter of Example 11 includes, determining an end to the user visit associated with the predicted venue, the determining of the end to the user visit comprising: receiving an additional user location; retrieving an additional set of candidate venues based on the additional user location; retrieving additional check-in data associated with each additional candidate venue of the set of additional candidate venues; predicting an additional venue score for each additional candidate venue of the set of additional candidate venues, using at least one of the ML model, the additional check-in data for each additional candidate venue, or the additional user location; identifying an additional candidate venue of the set of additional candidate venues with a highest predicted additional venue score as the predicted additional venue; and determining that the predicted additional venue differs from the predicted venue.

In Example 13, the subject matter of Examples 1-12 includes, displaying, on a user interface (UI) of a second computing device, a map comprising a visual indicator associated with the user in a vicinity of a visual indicator associated with the predicted venue.

In Example 14, the subject matter of Example 13 includes, wherein the second computing device is associated with a connection of the user.

Example 15 is at least one machine-readable medium including instructions that, when executed by processing circuitry, cause the processing circuitry to perform operations to implement of any of Examples 1-14.

Example 16 is an apparatus comprising means to implement any of Examples 1-14.

Example 17 is a system to implement any of Examples 1-14.

### Glossary

“Carrier signal” includes, for example, any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” includes, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” includes, for example, one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” includes, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” includes, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” includes, for example, a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” includes, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” includes, for example, a tangible medium that is capable of storing, encoding, or carrying the instructions for execution by a machine.

“Signal medium” includes, for example, any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” includes, for example, a device accessed, controlled or owned by a user and with which the user interacts perform an action or interaction on the user device, including an interaction with other users or computer systems.

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

What is claimed is:

1. A method comprising:
receiving, at a computing device, a user location;
retrieving a set of candidate venues based on the user location;
retrieving check-in data associated with each candidate venue of the set of candidate venues, the check-in data comprising user check-ins for a plurality of users;
predicting a venue score for each candidate venue, the predicting using one or more of a machine learned (ML) model, the check-in data for the candidate venue, or the user location;
identifying a candidate venue of the set of candidate venues with a highest predicted venue score as a predicted venue for the user location;
determining that a user visit is associated with the predicted venue; and
storing data indicating that the user visit is associated with the predicted venue.

2. The method of claim 1, wherein the user location comprises a latitude and a longitude.

3. The method of claim 1, wherein the check-in data for each candidate venue comprises a plurality of latitude and longitude pairs.

4. The method of claim 1, wherein features of the ML model comprise conditional probabilities associated with the candidate venues, each conditional probability for a respective venue corresponding to a probability that the user location is generated by a probability distribution corresponding to check-in data associated with the venue.

5. The method of claim 4, wherein generating the conditional probability for the venue further comprises:
determining parameters of the probability distribution based on the check-in data associated with the venue; and
computing the probability that the user location data is generated by the probability distribution with the determined parameters.

6. The method of claim 4, wherein the probability distribution is a bivariate Gaussian probability distribution.

7. The method of claim 1, wherein the ML model is a supervised multi-class classifier.

8. The method of claim 1, further comprising:
receiving an updated user location;
retrieving an updated set of candidate venues based on the updated user location;
retrieving updated check-in data associated with each updated candidate venue of the set of updated candidate venues;
predicting an updated venue score for each updated candidate venue, of the set of updated candidate venues, using at least one of the ML model, the updated check-in data for each updated candidate venue, or the updated user location; and
identifying an updated candidate venue of the set of updated candidate venues with a highest predicted updated venue score as the predicted updated venue.

9. The method of claim 8, wherein determining the user visit associated with the predicted venue further comprises determining that the predicted venue matches the predicted updated venue.

10. The method of claim 9, wherein determining the user visit associated with the predicted venue further comprises determining that a time period between receiving the user location and receiving the updated user location transgresses a predefined duration threshold.

11. The method of claim 10, wherein determining the user visit associated with the predicted venue further comprises determining that:
a predicted venue score associated with the predicted venue transgresses a first confidence threshold; and
a predicted updated venue score associated with the predicted updated venue transgresses a second confidence threshold.

12. The method of claim 11, further comprising determining an end to the user visit associated with the predicted venue, the determining of the end to the user visit comprising:
receiving an additional user location;
retrieving an additional set of candidate venues based on the additional user location;
retrieving additional check-in data associated with each additional candidate venue of the set of additional candidate venues;
predicting an additional venue score for each additional candidate venue of the set of additional candidate venues, using at least one of the ML model, the additional check-in data for each additional candidate venue, or the additional user location;
identifying an additional candidate venue of the set of additional candidate venues with a highest predicted additional venue score as the predicted additional venue; and
determining that the predicted additional venue differs from the predicted venue.

13. The method of claim 1, further comprising:
displaying, on a user interface (UI) of a second computing device, a map comprising a visual indicator associated with the user in a vicinity of a visual indicator associated with the predicted venue.

14. The method of claim 13, wherein the second computing device is associated with a connection of the user.

15. A system comprising:
at least one processor;
at least one memory component storing instructions that, when executed by the at least one processor, cause the at least one processor to perform operations comprising:
receiving, at a computing device, a user location;
retrieving a set of candidate venues based on the user location;
retrieving check-in data associated with each candidate venue of the set of candidate venues, check-in data comprising user check-ins for a plurality of users;
predicting a venue score for each candidate venue, the predicting using one or more of a machine learned (ML) model, the check-in data for the candidate venue, or the user location;
identifying a candidate venue of the set of candidate venues with a highest predicted venue score as a predicted venue for the user location;
determining that a user visit is associated with the predicted venue; and
storing data indicating that the user visit is associated with the predicted venue.

16. The system of claim 15, wherein the user location comprises a latitude and a longitude.

17. The system of claim 15, wherein the check-in data for each candidate venue comprises a plurality of latitude and longitude pairs.

18. The system of claim 15, wherein features of the ML model comprise conditional probabilities associated with the candidate venues, each conditional probability for a respective venue corresponding to a probability that the user location is generated by a probability distribution corresponding to check-in data associated with the venue.

19. The system of claim 18, wherein generating the conditional probability for the venue further comprises:
determining parameters of the probability distribution based on the check-in data associated with the venue; and
computing the probability that the user location data is generated by the probability distribution with the determined parameters.

20. A non-transitory computer-readable storage medium storing instructions that, when executed by at least one processor, cause the at least one processor to perform operations comprising:
receiving, at a computing device, a user location;
retrieving a set of candidate venues based on the user location;
retrieving check-in data associated with each candidate venue of the set of candidate venues, check-in data comprising user check-ins for a plurality of users;
predicting a venue score for each candidate venue, the predicting using one or more of a machine learned (ML) model, the check-in data for the candidate venue, or the user location;
identifying a candidate venue of the set of candidate venues with a highest predicted venue score as a predicted venue for the user location;
determining that a user visit is associated with the predicted venue; and
storing data indicating that the user visit is associated with the predicted venue.
